(19) United States
(12) Patent Application Publication
(10) Pub. No.: US 2011/0188941 A1
(43) Pub. Date: Aug. 4, 2011

(54) APPARATUS FOR USE IN LAYING PIPE ON THE SEA FLOOR

(75) Inventor: Jonathan Richard Tame, Aberdeenshire (GB)

(73) Assignee: SUBSEA 7 LTD., Aberdeenshire, Scotland (GB)

(21) Appl. No.: 13/059,220

(22) PCT Filed: Aug. 12, 2009
(86) PCT No.: PCT/EP09/60437

§ 371 Date: Apr. 25, 2011

(30) Foreign Application Priority Data
Aug. 15, 2008 (GB) 0814979.1

(51) Int. Cl. F16L 1/12

(52) U.S. Cl. 405/166

(57) ABSTRACT

When laying pipe from a pipelay vessel into the sea, the pipe is subject to torsion. To relieve this torsion an apparatus to perform controlled relative rotation between the pipe and the vessel is proposed, which apparatus is also able to permit the pipelay vessel to “weather vane” about the pipe without twisting it. The apparatus comprises a hold off clamp (3) which is mounted within a housing (5) via thrust bearings (4). The housing (5) is mounted to the vessel (6), and the clamping means (3) is clamped to the pipe (1). A brake assembly (12) and a drive means (13) capable of providing predetermined rotation and torsional damping, enable controlled relative rotation of the clamping means within the housing. With the pipe secured in the clamping means controlled relative rotation can be achieved for torsion relief, or weather vaning of the pipelay vessel about the pipe can be achieved.

In laying pipe from a pipelay vessel it is well known that the pipe is subject to torsion and that this induces a residual unrelieved torque in the pipe.

This torque needs to be released before undertaking a pipe joining operation, and/or the attachment of in-line and/or end modules etc. This is particularly the case for in-line modules, which are launched in a preferred orientation relative to the sea floor, as any residual torque in the pipes can adversely affect their alignment for the final lay down process on the sea floor.

Thus there is a need for means which permit the torque to be relieved.

There is also a need for the pipelay vessel to be able to “weather vane” about the pipe without twisting it. This can only be achieved when a pipe end is held in a hold off clamp (HOC), in other words when there is no pipe running up a pipelay system above the HOC.

A current torque release technique involves attaching an Abandonment and Recovery (A&R) winch line via a swivel to the pipe end whilst the latter is retained by clamps in the HOC. The load is then taken up on the A&R winch, the HOC clamps are retracted, and the twist is taken out by the swivel. This approach involves fixing an A&R attachment head to the pipe end by means of high quality welds. This task can take several hours of valuable vessel time and it is not possible to load test this joint prior to use.

An alternative technique has already been proposed in UK patent application 0810201.4, in which an arrangement, referred to hereinafter as a twister, grips the pipe above the HOC with “bear grips” that rest on a thrust bearing. The HOC can then be released and the twist taken out by rotation of the “bear grips” on the thrust bearing. Prior to releasing the HOC, the thrust bearing can be pre-loaded by a jacking system. This process can also be used to test the load holding power of the “bear grips” which rest on it.

Weather vaning of the pipelay vessel is not specifically addressed by either the A&R based system, or by the twister system, but both are capable of it.

The present invention is concerned with providing an alternative to the A&R and twister systems, and in particular to avoid the need to rig and use the A&R winch system, and thus to decrease the timescales involved.

According to one aspect of the present invention there is provided an apparatus adapted to achieve controllable relative rotation between a pipe, being laid on the sea floor from a floating pipelay vessel, and the pipelay vessel, the apparatus comprising: a hold off clamp, for disposal on the pipelay vessel and comprising clamping means adapted to be secured to the pipe at a position along a lay path taken by the pipe during laying from the pipelay vessel and adapted to support the weight of the laid pipe, and wherein the clamping means is mounted within a housing by means adapted to provide controllable relative rotation of the clamping means within the housing around the lay path, and wherein the housing is adapted to be secured to the pipelay vessel.

The means adapted to provide controllable relative rotation of the clamping means within the housing may comprise thrust bearings via which the clamping means is mounted on the housing, a brake assembly capable of presenting said relative rotation and drive means capable of providing predetermined rotation and torsional damping.

The brake assembly may comprise brake actuation means and disc pads mounted to the housing and co-operable with a projection of the clamping means comprising a brake disc.

The drive means may comprise means mounted to the housing and co-operable with means of the clamping means.

The clamping means may be hydraulically operable.

The hold off clamp may include means for releasably connecting the clamping means to a hydraulic supply of the pipelay vessel.

Means may be mounted to the clamping means for co-rotation therewith, for maintaining the clamping means secured to the pipe when the releasable connecting means are disconnected.

The clamping means may comprise a plurality of clamping jaws disposed around the circumference of the pipe in use thereof and operable by clamping cylinders orthogonal to the pipe to grip the pipe.

The clamping means may comprise a plurality of clamping jaws disposed around the circumference of the pipe in use thereof and operable by radius arms pivotably mounted to the clamping jaws and the body of the clamping means, initial grip of the pipe being achieved by pivoting of the radius arms caused by respective operating cylinders, and subsequent grip being maintained in proportion to the weight of the pipe.

Mounted to the clamping means and co-rotational therewith may be telemetry means for monitoring the clamping means holding pressure and/or adjusting the drive means.

The clamping means and the housing may be in the form of a split structure to facilitate disposal around the pipe.

In the case of use with a pipe of a pipe-in-pipe construction having an inner pipe and an outer pipe, one said hold off clamp may be adapted to secure the outer pipe and another said hold off clamp may be adapted to support the inner pipe. Alternatively, the hold off clamp may be adapted to secure the outer pipe and a twister arrangement may be provided and employed to secure the inner pipe and adapted to support the weight of the inner pipe.

According to another aspect of the present invention there is provided a method for use in connection with the laying of pipe on the sea floor from a floating pipelay vessel, comprising the steps of: mounting a housing means to the pipelay vessel; mounting a clamping means, adapted to secure the pipe and support the weight of the pipe, in the housing means with provision for controllable relative rotation with respect to the housing means; securing the pipe in the clamping means; and performing relative rotation of the clamping means with respect to the pipelay vessel.

Relative rotation may be performed and controlled in order to relieve residual torsion in the pipe.

Relative rotation may serve to permit weather vaning of the pipelay vessel about the pipe.

In the case of a pipe-in-pipe construction of pipe having an inner and an outer pipe, the outer pipe may be secured by the housing means and the clamping means, and the method may include the steps of mounting a further device to the pipelay vessel, which further device serves to secure the inner pipe and support its weight.

The further device may comprise a respective housing means and clamping means. Alternatively, the further device may comprise a twister arrangement.

For a better understanding of the invention and to show how the same may be carried into effect, reference will now be made, by way of example, to the accompanying drawings, in which:

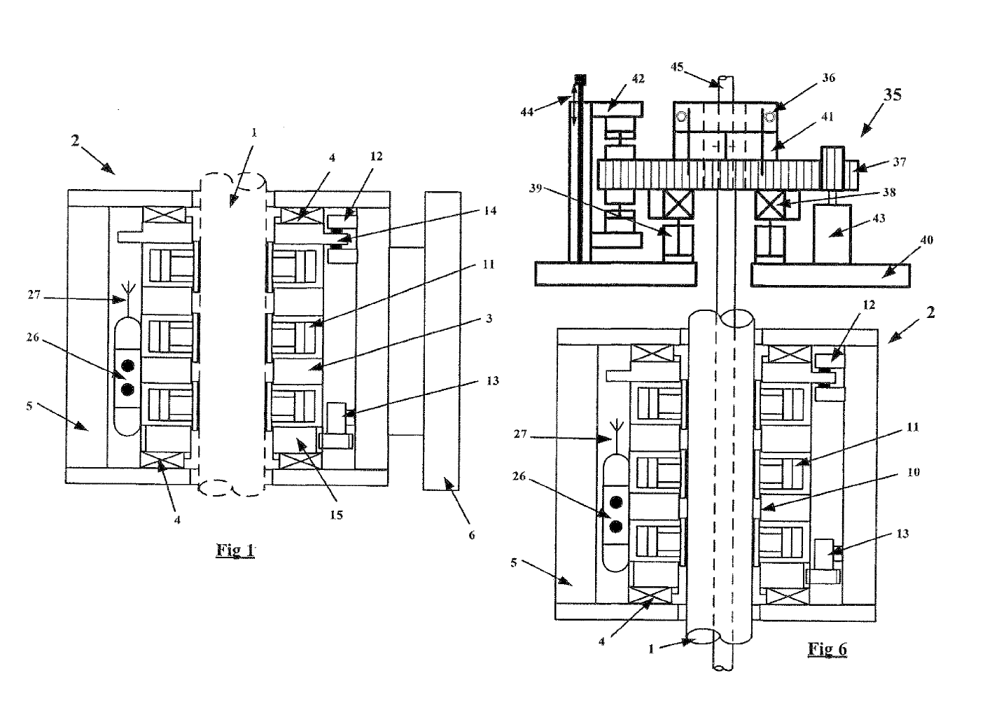

FIG. 1 shows schematically the structure of an apparatus (rotatable hold off clamp), in a sectional side view and attached to the pipelay vessel, which is adapted to achieve controlled relative rotation between a pipe and the pipelay vessel, particularly but not exclusively for relieving torque in the pipe, and which is for use in connection with a single pipe;

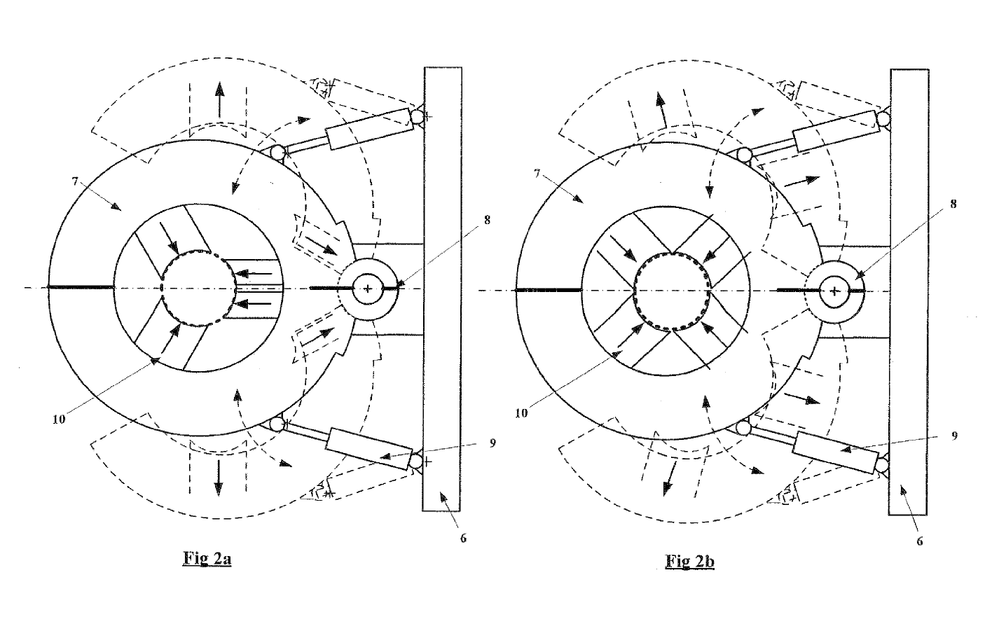

FIGS. 2a and 2b show plan views of a rotatable hold off clamp, attached to the pipelay vessel, which has a split structure and indicating by solid lines the structure when closed and by dashed lines the structure when opened, FIG. 2a representing a three clamp version and FIG. 2b representing a four clamp version;

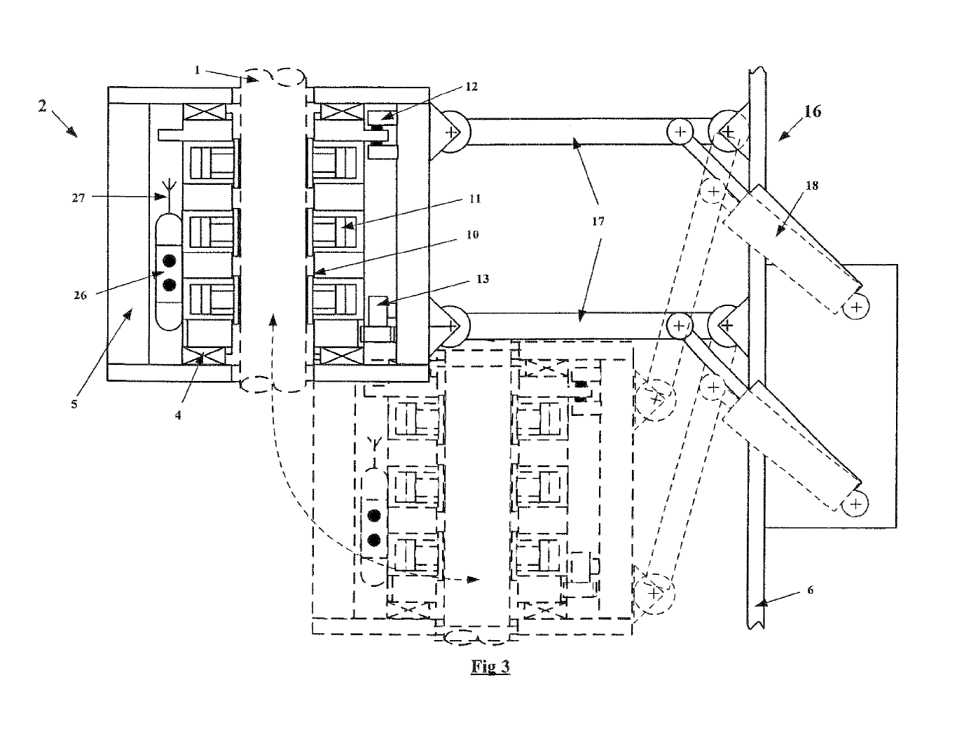

FIG. 3 shows schematically the rotatable hold off clamp of FIG. 1 together with a deploying/stowing mechanism, in both the deployed (solid lines) and stowed (dashed lines) positions;

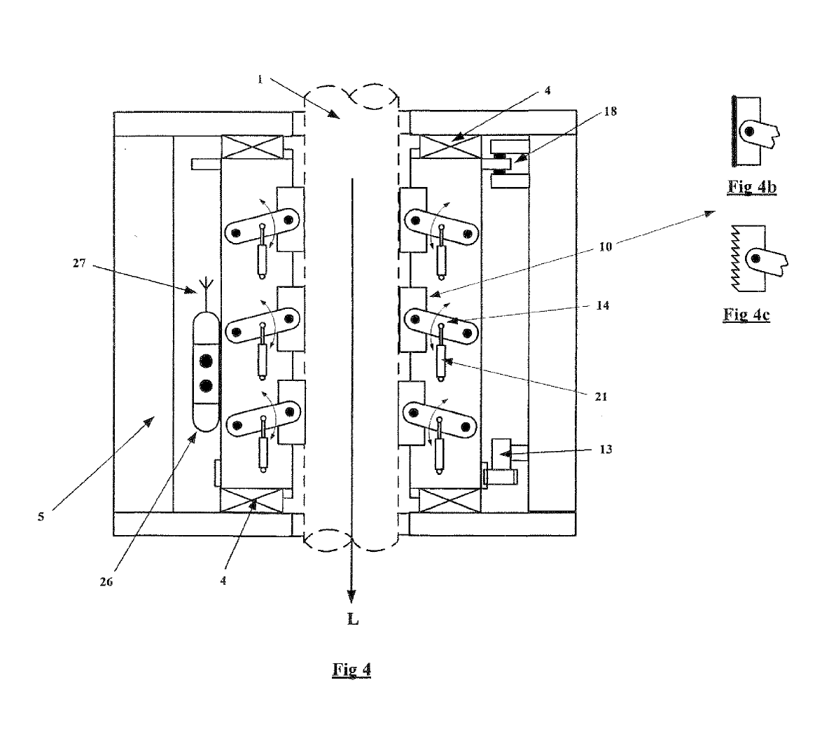

FIG. 4a shows an alternative construction of the rotatable hold off clamp which employs self-gripping clamps, and FIGS. 4b and 4c show respectively specific forms of the jaws of the clamps;

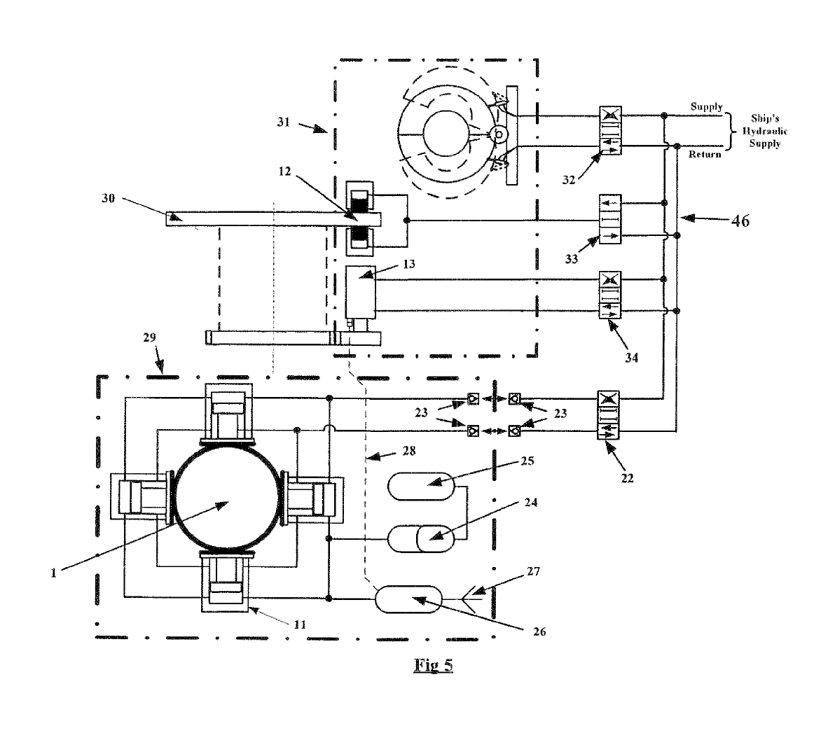

FIG. 5 shows schematically elements of the rotatable hold off clamp, with a four clamp arrangement, and the system power and controls, in particular the hydraulic connections;

FIG. 6 shows a construction suitable for use with pipe-in-pipe, which employs a twister for the inner pipe, disposed adjacent to a rotatable hold off clamp with the structure illustrated in FIG. 1.

During pipe laying operations, in the event that a pipe has to be cut, the pipe end is first gripped at approximately deck level of the pipe laying vessel by a hold off clamp. This retains it against the load of the pipe suspended between it and the sea floor. The latter is a force of the order of two to three hundred tonnes.

Referring to FIG. 1, a pipe 1 can be held by a rotatable hold off clamp 2 which comprises a hold off clamp clamping means 3 mounted on thrust bearings 4, all supported by a housing or chassis 5. The chassis is mounted to the structure of the vessel, illustrated schematically at 6, which may comprise part of a deploying/stowing mechanism described further in connection with FIG. 3.

When setting up a pipelay system, it is not always possible to feed the pipe end through the hold off clamp, and thus the rotatable hold off clamp of the present invention has a hinged/split structure so that it can be opened to accept a pipe 1, closed around it, and then locked shut. Such an openable structure will also allow the through passage of smaller items attached to the pipe 1, for example anodes.

Further details of the hinged/split structure can be appreciated from FIG. 2a or 2b which show the closed configuration in solid lines, and the opened configuration in dashed lines, in a plan view.

The hold off clamp comprises two sections 7 with a clamp hinge 8 so that the sections 7 are openable, and is mounted to the vessel structure 6. Hydraulic operating cylinders 9 are illustrated as comprising means for controlling the opening and closing operation of the hold off clamp sections 7.

In order to enable the opening and closing of the hold off clamp, the clamping means 3, the chassis 5 and the thrust bearings 4 will be of a suitably split design. A conventional hold off clamp may also have a split design but does not include the thrust bearings.

Various pipe gripping systems may be employed. In the arrangement illustrated schematically in FIG. 2a there are three clamping jaws 10 disposed around the circumference of the pipe to be clamped, and as illustrated in FIG. 1 there may be three such sets of clamping jaws disposed along the length of the pipe.

The solid line drawing of FIG. 2a shows the clamping jaws in contact with a pipe, whereas the dashed line indicates the clamping jaws retracted.

The clamping jaws are operated by hydraulic clamping cylinders 11 in the embodiment illustrated in FIG. 1, and the clamping jaws 10 are positioned orthogonally to and around the pipe. In the case of a set of three clamping jaws around the pipe, one clamp will be of a split construction and this is adjacent to the hinge 8 and provides the base against which the pipe is pushed by the other two clamping jaws.

In an alternative arrangement the set of clamping jaws comprises four clamping jaws 10, as illustrated in FIG. 2b, in which case no clamping jaw which is split is required, thus facilitating manufacture and operation.

The clamping jaws may be plastic/rubber lined or have teeth as illustrated in FIGS. 4b and 4c in connection with an alternative type of structure.

As discussed above, the clamping means 3 is mounted on the chassis 5 via thrust bearings 4. The thrust bearings 4 mean that the clamping means 3 is free to rotate relative to the chassis 5 and the vessel 6 on which it is mounted, in order to remove the residual twist in the pipe and allow the vessel to “weather vane” about the pipe.

The torque relief operation will be controlled by a brake assembly 12, and/or a rotary damper and drive motor 13, so that stored energy in the pipe can be relieved in a controllable manner.

An annular projection 14 of the clamping means 3 may form a brake disc in the illustrated case of a disc brake assembly. The rotation characteristics of the clamping means 3 during pipe torque release can be controlled by the rotary damper 13 which engages with a toothed annular section 15 of the clamping means 3, which can alternatively be driven by the drive motor incorporated in the rotary damper. This also allows the pipe 1 to be twisted if required. Such a drive facility permits the alignment of pipe joint faces for welding, for example. Whilst a disc brake assembly is particularly described, other brake types (non-disc) could be employed, such as a band brake around the clamping means 3.

The rotatable hold off clamp 2 may be mounted so that it can be swung clear of the line (lay path) adopted by a pipe during laying, in order to allow the passage of large items that may be attached to the pipe, for example in-line modules, pipeline end terminations (PLETs) etc.

FIG. 3 shows a deploying/stowing mechanism for the rotatable hold off clamp 2. The solid lines of the drawings illustrate the deployed position and the dashed lines indicate the stowed position. Whereas in FIG. 1 the rotatable hold off clamp 2 is illustrated as fixed directly to the vessel structure 6, in FIG. 3 there is illustrated an intermediate deploying/stowing mechanism 16 comprising swinging arms 17 attached to the chassis 5 and the vessel structure 6 and positions of which are controlled by operating cylinders 18 which cause the rotatable hold off clamp to be moved between the deployed and stowed positions.

In FIG. 4a there is shown an alternative clamping arrangement to the orthogonal arrangements illustrated in FIGS. 2a and 2b.

Three or four sets of jaws may be set around the pipe 1 as was described for the orthogonal clamps, but in this case the jaws are connected to radius arms 19 which are pivotably mounted at one end to the jaw per se 10 and at the other end to body 20 of the clamping means. The jaws 10 are pulled onto the pipe 1 by operating cylinders 21 to create an initial grip. The jaws 10 then work in combination with the radius arms 19 so that the weight of the pipe 1 acting on the jaws increases the grip in the correct proportion to prevent slip, but at the same time over-stressing of the pipe wall is avoided. Consequently having generated the initial grip, further input from the operating cylinders 21 is not required. The jaws 10 may be plastic/rubber lined as illustrated schematically in FIG. 4b, or have teeth as illustrated schematically in FIG. 4c.

The rotatable hold off clamp 2 may be driven by hydraulic power supplied over an hydraulic circuit 46 from the lay vessel, as illustrated schematically in FIG. 5. An orthogonal clamp arrangement is illustrated in FIG. 5, but the arrangement for the self gripping jaws of FIG. 4a will be similar, except that the hydraulic fluid will be directed to the radius arm operating cylinders 21, rather than the clamping cylinders 11, from a clamping control valve 22 whose operating position determines whether the pipe is gripped or released, the clamping control valve 22 additionally having an off position.

Since it may be necessary for “weather vaning” for the relative rotation between the pipe and the vessel to be 360° degrees or more, rather than having hydraulic slip rings for a rotatable assembly 30 including the clamping means 3, it can be equipped with “quick connect” hydraulic couplings 23. These can be “connected” when necessary to operate the damping functions, and then “broken” so that the rotatable clamping means 3 is free to rotate 360 degrees or more. At this time the clamping force may be maintained by a hydraulic accumulator 24 pressurised by a pressurising cylinder 25, for example using nitrogen gas, both of which will also be mounted on the rotatable assembly. The hydraulic circuit 46 is connected to an instrumentation module 26 so that the clamp holding pressure can be monitored via telemetry using, for example, an aerial 27, particularly in the case where the quick connect hydraulic couplings are employed and the clamping means 3 is required to rotate independently.

As indicated in FIG. 5, the telemetry module may be connected to the rotary damper 13 by a control line 28 in order to control the torsion damping and rotation as required. This control line may be hydraulic or electrical.

The schematic illustration in FIG. 5 indicates within box 29 those elements which are mounted on the hold off clamp rotatable assembly 30, and within box 31 those elements mounted on the hold off clamp chassis 5, in particular the brake assembly 12 and the rotary damper and drive motor 13.

The vessel's (ship's) hydraulic supply (not shown) is connected to the operating cylinders 9 via hold off clamp open/shut control valve 32, the brake assembly 12 via a brake control on/release/off valve 33, and to the rotary damper and drive motor 13 via a drive control left/right/off valve 34.

The rotation of the rotatable assembly can be controlled by the brake and rotary damper. The brake enables locking/releasing of the rotatable assembly as and when required, and the rotary damper can provide a controlled rate of rotation and minimise post release oscillations (bounce). The rotary damper can incorporate the drive motor, or it can be a separate unit, which drive motor can be used for positioning the rotary assembly in azimuth as required.

In the case of a pipe-in-pipe construction of pipe having an inner pipe and an outer pipe, the outer pipe 1 may be secured in a rotatable hold off clamp 2, whilst the inner pipe may be secured by a twister 35, as illustrated in FIG. 6 in which a twister is located on a support structure 40 mounted to the pipelay vessel and secured to an inner pipe 45.

The twister 35 comprises a pair of “bear grips” 36, constituting a securing means, in particular a clamping means which is disposed on the pipelay vessel and clamped to the inner pipe 45. The clamping means 36 is such as to be able to support the weight of the inner pipe suspended between it and the sea floor. These bear grips or clamping means 36 rest on a turntable 37 which is supported on a thrust bearing 38 rated to carry the weight of the inner pipe. The thrust bearing 38 is supported on pipe tensioning cylinders 39 whose lower ends are fixed to a top surface of the support structure 40 on which all of the twister components are mounted.

The turntable 37 is connected to the clamping means 36, and thence to the inner pipe 45, by drive pins 41, and is rotationally lockable by a brake assembly 42 for which it forms a brake disc. The rotation characteristics of the turntable during pipe torque release can be controlled by a torsional damper 43. Whilst a disc brake arrangement is particularly described, other brake types (non-disc) could be employed.

The turntable 37 also serves as a drive wheel which can be rotated by a drive motor incorporated in the torsional damping unit 43. This allows the inner pipe 45 to be twisted, thus facilitating, for instance, the alignment of pipe joint faces for welding.

The pipe-tensioning cylinders 39 below the thrust bearing 38 provide a means whereby the latter can be jacked up and thus pre-loaded to the pipe weight and thus protect the bearing 38 from shock loads. It should be noted that the majority of the components of the twister will be in two inter-connecting halves so that the unit can be installed around a continuous pipe, and opened to allow the passage of large items.

Brake assembly guide rods 44 serve to allow the brake assembly 42 to move up and down with the pipe 45 and the turntable 37 as the axial load is applied/removed via the cylinders 39.

The elements of the twister other than the clamping means 36 comprise a mounting means for the clamping means adapted to provide controlled relative rotation of the clamping means with respect to the pipe lay vessel and around the lay path, in particular these elements are the turntable 37, the thrust bearing 38, the support structure 40, the brake assembly 42 and the drive means 43, which acts as a drive motor or a torsional damping unit.

When working with the pipe-in-pipe construction it is necessary to be able to fix the inner pipe 45 to the outer pipe 1, so that when the inner pipe is cut, it is prevented from falling irretrievably down inside the outer pipe.

In general, it is considered that, unlike the outer pipe, inner pipe torsion very often does not manifest itself, due to friction with the outer pipe, so that independent torsion release is less necessary, with the result that in this case, once the torque has been released from the outer pipe, the two pipes can be locked together using a pair of slip wedge elements, as discussed in further detail in the above-mentioned co-pending application.

Particularly when the pipelay moves into ever deeper water, it may be found that the inner pipe has also acquired a residual torsion, and this may or may not match the outer pipe. It may be more, less or even of the opposite rotation, in which case the slip elements are not required.

Various methods of operation using the rotary hold off clamp described above will now be described.

In the case of pipe laying setup, for a single pipe 1 and the pipe free end being available, if necessary the rotatable hold off clamp 2 will be deployed into the line of lay (lay path), as discussed above with reference to FIG. 3. The rotatable assembly 3 is then rotated as necessary and the brake assembly 12 applied by appropriate control of the brake valve 33. The clamping cylinders 11 are then connected to the hydraulic supply via the quick connects 23, and the clamps are released by appropriate control of the clamping control valve 22, so that the pipe 1 can be led up/down through the rotary hold off clamp 2.

The rotatable hold off clamp is then ready for use, the hydraulic supply to the clamping means 3 remaining connected/being disconnected depending on the intended use.

If no free end of the pipe is available, then the procedure for pipe laying setup is as follows. If necessary the rotary hold off clamp 2 is deployed into the line of lay (lay path), the clamping means is rotated as necessary, the brake applied and the clamps retracted (released). Then the rotatable hold off clamp is hinged open, the pipe fed in between the two halves 7, which are then powered shut by the operating cylinders 9, and the halves locked together. The rotatable hold off clamp 2 is then ready for use, the hydraulic supply to the rotatable assembly 3 remaining connected/being disconnected depending on the intended use.

A number of pipelay operations, for example the insertion of a mid line module, a pipeline end termination etc., require that the pipe be cut so that a joint can be made with the item being inserted or attached. This cannot safely be done without first relieving the residual torque locked up in the pipe.

To do this, the pipe 1 is disposed in the rotatable hold off clamp 2 as described above and held therein by application of hydraulic pressure to the clamping cylinders 11 to cause the clamping jaws to grip the pipe 1 and the brake assembly 12 applied. With the pipe held in the rotatable hold off clamp, the pipe is cut above it, and then the upper part retracted to give a clear working space above the pipe end in the clamping jaws.

To remove the residual torque, the rotary damper 13 set to a predetermined figure commensurate with the pipe type, depth of operation, length of lay etc.

The brake assembly 12 is then released, and the pipe 1 un-twists under the control of the rotary damper 13. The brake assembly 12 can be used to augment the rotary damper function by remaining partially applied.

With the pipe end remaining gripped in the rotatable hold off clamp, the appropriate joining operation is carried out.

Subsequently the clamping jaws are released, by appropriate control of the valve 22, the clamp sections 7 unlocked and swung apart, and if necessary the rotatable hold off clamp moved to its stowed position, the dotted line position shown in FIG. 3. Laying of the pipe to the sea bed then recommences.

In the case of a pipe-in-pipe construction the operation of the rotatable hold off clamp 2 for gripping the pipe 1 will correspond with that described above, and the twister 35 will be employed in connection with the inner pipe 45.

It will be necessary to deploy the twister 35 in a position above the rotatable hold off clamp 2, and open the twister structure if no free end of the pipe-in-pipe is available. The inner pipe will be clamped by the bear grips 36 and depending on the depth of water, slip wedges and operation of the twister will be involved in order to allow the inner pipe to untwist if necessary. In deep water the twister 35 will relieve the torsion on the inner pipe 48, whilst the rotary hold off clamp 2 will relieve the torsion in the outer pipe.

Once this has been achieved the necessary jointing operations can be carried out and the twister and the hold off clamp moved to a stowed position as necessary.

Whilst a twister has been described for use with the inner pipe of a pipe-in-pipe construction, this is not the only possibility, for example another rotatable hold off clamp could be disposed above clamp 2 in a position occupied in FIG. 6 by the twister 35. In the case of use of two rotatable hold off clamps, the hydraulics arrangement would need to be duplicated, with various functions on each clamp capable of control individually and/or simultaneously as appropriate. In the case of a rotatable hold off clamp and a twister, in order for the vessel to weather vane, the brakes would have to be released simultaneously on the rotatable hold off clamp and the twister, and the drive motors/dampers of both would have to be in the minimal damping/non driving mode.

As will be apparent from the above description, in the proposed rotatable hold off clamp 2, the torque release elements are inbuilt, and so no additional equipment is required for a single pipe 1, such as is the case with the twister in addition to the standard HOC as described above. The hold off clamp provides the functions of clamping and torsion release. This results in a more compact unit, and the number of operational steps is reduced, thus making for a quicker de-twisting operation as well as facilitating installation on the lay vessel.

Having adequate pipe holding power is intrinsic to the design of the rotatable hold off clamp, and so pre-use load testing which is necessary for a twister arrangement, for example, at every joining operation is not required.

The need to rig and use the A&R system is avoided, together with the need to make high quality welds for attaching the A&R pad eye.

By virtue of the provision of the hydraulic accumulator 24 and its pressurising cylinder 25 which are mounted on the rotatable assembly 30, the clamping force on the pipe 1 can be maintained whilst the vessel weather vanes around the pipe as a result of the rotation permitted by the thrust bearings 4 within the chassis 5 which is mounted to the vessel. In practice, because of the limited thruster power on the lay vessel, the amount of weather vaning permitted will actually be limited to a few degrees, for example ±5 degrees. This is because if the lay vessel should end up at, say, 90 degrees to the pipe, then in order to stay in position, and maintain the pipe tension, the thrusters would have to be powerful enough to balance the environmental forces (wind, waves, current etc.) acting broadside on. Any other angle down to zero degrees would of course involve forces in proportion.

What is claimed is:

1.-19. (canceled)

20. An apparatus adapted to achieve controllable relative rotation between a pipe, being laid on the sea floor from a floating pipelay vessel, and the pipelay vessel, the apparatus comprising:
a hold off clamp, for disposal on the pipelay vessel and comprising a clamping device for securement to the pipe at a position along a lay path taken by the pipe during laying from the pipelay vessel and adapted to support the weight of the laid pipe,
and wherein the clamping device is mounted within a housing by an arrangement arranged to provide controllable relative rotation of the clamping device within the housing around the lay path, and wherein the housing is arranged to be secured to the pipelay vessel.

21. The apparatus as claimed in claim 20, wherein the arrangement is arranged to provide controllable relative rotation of the clamping device within the housing, and the arrangement comprises:
thrust bearings via which the clamping device is mounted on the housing,
a brake assembly capable of presenting said relative rotation, and
a drive arrangement capable of providing predetermined rotation and torsional damping.

22. The apparatus as claimed in claim 21, wherein the brake assembly comprises a brake actuator and disc pads mounted to the housing and co-operable with a projection of the clamping device comprising a brake disc.

23. The apparatus as claimed in claim 21, wherein the drive arrangement comprises a first part mounted to the housing and a second part of the clamping device, the first part being co-operable with the second part.

24. The apparatus as claimed in claim 20, wherein the clamping device is hydraulically operable.

25. The apparatus as claimed in claim 24, wherein the hold off clamp includes connecting elements for releasably connecting the clamping device to a hydraulic supply of the pipelay vessel.

26. The apparatus as claimed in claim 25, further including a securement arrangement mounted to the clamping device for co-rotation therewith, for maintaining the clamping device secured to the pipe when the releasable connecting elements are disconnected.

27. The apparatus as claimed in claim 25, wherein the clamping device comprises a plurality of clamping jaws disposable around the circumference of the pipe in use thereof and operable by clamping cylinders orthogonal to the pipe to grip the pipe.

28. The apparatus as claimed in claim 25, wherein the clamping device comprises a plurality of clamping jaws disposable around the circumference of the pipe in use thereof and operable by radius arms pivotably mounted to the clamping jaws and the body of the clamping device, initial grip of the pipe being achieved by pivoting of the radius arms caused by respective operating cylinders, and subsequent grip being maintained in proportion to the weight of the pipe.

29. The apparatus as claimed in claim 25, further comprising a telemetry device mounted to the clamping device and co-rotational therewith for monitoring the clamping device holding pressure and/or adjusting the drive arrangement.

30. The apparatus as claimed in claim 20, wherein the clamping device and the housing are in the form of a split structure to facilitate disposal around the pipe.

31. The apparatus as claimed in claim 20, comprising two hold off clamps and being arranged for use with a pipe of a pipe-in-pipe construction having an inner pipe and an outer pipe, wherein one said hold off clamp is adapted to secure the outer pipe and another said hold off clamp is adapted to support the inner pipe.

32. The apparatus as claimed in claim 20, arranged for use with a pipe of a pipe-in-pipe construction having an inner pipe and an outer pipe, wherein the hold off clamp is adapted to secure the outer pipe and a twister arrangement is provided and employed to secure the inner pipe and adapted to support the weight of the inner pipe.

33. A method for laying of pipe on the sea floor from a floating pipelay vessel, comprising the steps of:
mounting a housing to the pipelay vessel;
mounting a clamping device, adapted to secure the pipe and support the weight of the pipe, in the housing with provision for controllable relative rotation with respect to the housing;
securing the pipe in the clamping device; and
performing relative rotation of the clamping device with respect to the pipelay vessel.

34. The method as claimed in claim 33, wherein the step of relative rotation comprises relieving residual torsion in the pipe.

35. The method as claimed in claim 33, wherein the step of relative rotation comprises permitting weather vaning of the pipelay vessel about the pipe.

36. The method as claimed in claim 33, and for use with a pipe-in-pipe construction of pipe having an inner pipe and an outer pipe, wherein the outer pipe is secured by the housing and the clamping device, the method including the steps of mounting a further device to the pipelay vessel in a manner that secures the inner pipe and supports its weight.

37. The method as claimed in claim 36, wherein the further device comprises a respective housing and clamping device.

38. The method as claimed in claim 36, wherein the further device comprises a twister arrangement.
